(19) United States
(12) Patent Application Publication
(10) Pub. No.: US 2015/0330368 A1
(43) Pub. Date: Nov. 19, 2015

(54) AIRBORNE WIND ENERGY SYSTEM WITH ROTARY WING, FLYING GENERATOR AND OPTIONAL MULTI-LEG TETHER

(71) Applicant: Leonid Goldstein, Austin, TX (US)

(72) Inventor: Leonid Goldstein, Austin, TX (US)

(21) Appl. No.: 14/706,005

(22) Filed: May 7, 2015

Related U.S. Application Data
(60) Provisional application No. 61/994,962, filed on May 18, 2014.
(60) Provisional application No. 62/002,703, filed on May 23, 2014.
(60) Provisional application No. 62/026,668, filed on Jul. 20, 2014.

(51) Int. Cl. F03D 11/04; F03D 7/04; F03D 9/00

(52) U.S. Cl. CPC F03D 11/04; F03D 9/002; F03D 7/042

(57) ABSTRACT

An airborne wind energy system with a rotary wing (a wind rotor) and a flying generator is disclosed. Among the features of the disclosed system: use of aerodynamic lift in combination with buoyant lift, supporting rotor blades with suspension cables, use of peripheral or mid-rotor power take off. Use of multiple rotary wings and other related methods and subcomponents are also described. Also, use of tether multi-legs (including tripods and quadro-pods) for support of airborne wind energy systems in flight is disclosed.

### CROSS REFERENCE TO RELATED APPLICATIONS

This Application claims the benefit of priority of the U.S. Provisional Applications No. 61/994,962, filed 18 May 2014, No. 62/002,703, filed 23 May 2014 and No. 62/026,668, filed 20 July 2014, by the same inventor as herein, the entire disclosure of which is incorporated herein by reference.

### BACKGROUND OF THE INVENTION

This invention is generally directed to airborne wind energy conversion systems and methods. “Wind energy conversion” means conversion of wind energy to electricity or another sort of energy, usable outside of the conversion system. Airborne wind energy conversion systems (AWES or AWECS) have been seriously considered for producing electrical power and other industrial purposes since 1970's. Nevertheless, multiple technical obstacles prevented development and commercial deployment of such systems. As with the aircraft, one way of classifying AWES is into a fixed wing and a rotary wing families. Most of the aspects of this invention relate to the rotary wing family.

U.S. Pat. No. 8,113,777 by Gianni Vergnano discusses a number of such systems, used either for ship traction or power generation. Unfortunately, he addressed neither the issues of the flight stability and control, nor efficient conversion of the harvested energy into electrical energy, thus rendering the discussion fruitless.

U.S. Pat. No. 8,421,257 by Dimitri Chernyshov discusses a more sophisticated device. Nevertheless, the discussed device is still not efficient enough because it is too heavy, wastes too much energy just to remain in the air and has to land when the wind is too weak.

U.S. Pat. No. 8,350,403 (Publication 2011/0101692 B2) by Nykolai Bilanyuk discusses AWES, having two propellers, installed on an airship. It relies on a fixed wing to counteract downward force resulting from wind pressure on propellers and tether pull. Neither it addresses the issue of weight of gearboxes (if any) and high cost of a conventional drivetrain. Thus, it is too complex and must be expensive.

U.S. Pat. No. 5,996,934 by Ellis Murph is relevant to extent that it discusses a tethered autogyro, but it is not related to wind energy conversion as defined above.

U.S. patent application Ser. No. 12/714,070 (Publication 2011/0057453 A1) by Bryan Roberts discusses another type of AWES with multiple propellers, but does not address the issue of weight of gearboxes (if any) and high cost of a conventional drivetrain.

Thus, there is still need for a cost efficient AWES as well as devices, methods and components thereof.

### SUMMARY OF THE INVENTION

The invention is directed to a device and a method for wind energy conversion using airborne surfaces.

Power take-off from the middle part of the rotor means power take-off in other place than the axle of the wind rotor. Typically, it is further than 1/20^{th} of the rotor diameter from the rotor axis.

Some of the embodiments and variations of the invention are summarily described below in the following articles:

A1. An airborne wind energy conversion system, comprising:
an airborne wind rotor, having a plurality of airfoil rotor blades;
the rotor is adapted to rotate around its axis under the power of wind; at least one external cable, attached to each rotor blade in such a way that is capable of supporting the blade against aerodynamic force; and
a tether, coupled to the external cables, the tether being attached to the ground.

A2. The system of Article A1, further comprising an airborne electrical generator, having an electric rotor rotationally coupled to the wind rotor.

A3. The system of any of Articles A1-A2, further comprising a lighter than air member, supporting the wind rotor.

A4. The system of any of Articles A1-A3, wherein the external cables are directly connected to the tether.

A5. The system of any of Articles A1-A4, comprising an even number of airborne wind rotors.

A6. The system of any of Articles A1-A5, wherein the electrical generator is of direct drive type.

A7. The system of any of Articles A1-A6, further comprising an electrical cable, connecting the electrical generator to an electrical circuit on the ground.

A8. The system of any of Articles A1-A7, wherein the blades can pitch.

B1. A method of converting wind power into electrical power using an airborne wind energy conversion system with a tether and a wind rotor with a plurality of airfoil blades, the method comprising: supporting each rotor blade against aerodynamic lift with at least one external cable, the cable being attached by one end to the blade and by another end to the tether or an extension of the tether.

B2. The method of Article B1, further comprising a step of providing an airborne electrical generator, having an electric rotor rotationally coupled to the wind rotor.

B3. The method of any of Articles B1-B2, wherein the wind rotor is supported by a lighter than air member.

B4. The method of any of Articles B1-B3, further comprising a step of using an electronic control system to control the wind rotor.

B5. The method of any of Articles B1-B4, wherein the external cables are directly connected to the tether.

B6. The method of any of Articles B1-B5, wherein there is an equal number of the wind rotors rotating clockwise and rotating counter-clockwise.

B7. The method of any of Articles B1-B6, wherein the electrical generator is connected to an electrical circuit on the ground by an electrical cable, combined with the tether.

B8. The method of any of Articles B1-B7, wherein the blades can pitch.

C1. An airborne wind energy conversion system, comprising:
an airborne wind rotor, having a plurality of airfoil rotor blades, the rotor is adapted to rotate around its axis under the power of wind;
at least one airborne drivetrain, comprising an electrical generator, the drivetrain being adapted for power take off from the middle part or periphery of the wind rotor;
a tether, attaching the wind energy system to the ground.

C2. The system of Article C1, wherein the drivetrain is adapted for power take off from the middle part of the wind rotor.

C3. The system of Article C1, wherein the drivetrain is adapted for power take off from the periphery of the wind rotor.

C4. The system of any of Articles C1-C3, wherein at least one external cable is attached to each rotor blade for support against aerodynamic forces.

C5. The system of any of Articles C1-C4, further comprising an electrical cable, connecting the electrical generator to an electrical circuit on the ground.

D1. A method of converting wind power into electrical power using a tethered airborne wind energy conversion system, harvesting wind power with a wind rotor having a plurality of airfoil blades, transferring harvested power to an airborne drivetrain, comprising an electrical generator, from the middle part or periphery of the wind rotor.

D2. The method of Article D1, wherein the harvested power is transferred from the middle part of the wind rotor.

D3. The method of Article D1, wherein the harvested power is transferred from the periphery of the wind rotor.

D4. The method of any of Articles D1-D3, wherein the wind rotor is stiffened by a plurality of external cables.

D5. The method of any of Articles D1-D4, further including the step of transferring electrical power from the electrical generator to an electrical circuit on the ground by an electrical cable, combined with the tether.

E1. An airborne wind energy conversion system, comprising:
a lighter than air balloon;
an energy converting assembly, attached to the balloon, the assembly comprising:
   an airborne wind rotor, having a plurality airfoil rotor blades, the rotor is adapted to rotate around its axis under the power of wind;
   an airborne electrical generator, adapted to be driven by the wind rotor;
   an electrical cable for connecting the electrical generator to an electrical circuit on the ground;
   a tether for attaching the assembly to an object on the ground;
wherein the axis of the wind rotor is tilted to approximately align with the tether line.

E2. The system of Article E1, further comprising an electronic control system, having a central processing unit, at least one sensor and at least one actuator, wherein the actuator is adapted to adjust the axis of the wind rotor.

E3. The system of Article E1, further comprising passive stabilization means.

E4. The system of any of Articles E1-E3, wherein the rotor blades are externally braced.

E5. The system of any of Articles E1-E4, wherein the electrical generator is adapted for power take-off from the middle part or periphery of the wind rotor.

E6. The system of any of Articles E1-E5, comprising an even number of wind rotors, half of which are adapted to rotate clockwise and half of which are adapted to rotate counter-clockwise.

E7. The system of any of Articles E1-E6, wherein the balloon is filled with hydrogen.

E8. The system of any of Articles E1-E7, wherein the balloon is filled with methane.

E9. The system of any of Articles E1-E8, further comprising an electrical cable, connecting the electrical generator to an electrical circuit on the ground.

F1. A method of converting wind power into electrical power, comprising:
using a lighter than air balloon to raise into air an assembly comprising:
   a wind rotor having a plurality of airfoil blades;
   an electrical generator, adapted to be driven by the wind rotor;
   an electrical cable, connecting the electrical generator to an electrical circuit on the ground;
   a tether, attaching the assembly to an object on the ground;
resisting the wind pressure on the assembly by tilting the axis of the wind rotor to approximately align with the tether line.

F2. The method of Article F1, further comprising providing an electronic control system, having a central processing unit, at least one sensor and at least one actuator, wherein he actuator is used to adjust the axis of the wind rotor.

F3. The method of Article F1, further comprising connecting passive stabilization means to the assembly.

F4. The method of any of Articles F1-F3, wherein the wind rotor is lightened through supporting each of the airfoil blades by external cables.

F5. The method of any of Articles F1-F4, wherein the assembly is lightened by power take off for the electrical generator from the middle part or periphery of the wind rotor.

G1. An airborne wind energy conversion system, comprising:
an airborne wind rotor, having a plurality of airfoil rotor blades;
   the rotor is adapted to rotate around its axis under the power of wind; an airborne electrical generator, having an electric rotor rotationally coupled to the wind rotor;
a tether, coupled to the airborne wind rotor, the tether being attached to the ground;
an elongated structural member, coupled to the electrical generator;
a counterweight, attached to the structural member in such a way as to prevent rotation of the electrical generator.

G2. The system of Article G1, further comprising a body, filled with a lighter than air gas.

H1. An airborne wind energy conversion system, comprising:
an airborne device, comprising at least one airfoil blade, adapted to harvest wind energy;
the device is attached to a plurality of tethers;
the plurality of tethers comprising at least three tethers of constant length;
the tethers are attached to the ground at substantial distance between each other.

H2. The system of Article H1, wherein the substantial distance equals or exceeds half of the altitude of the airborne device.

H3. The system of any of Articles H1-H2, further comprising a lighter than air balloon, supporting the plurality of tethers.

H4. The system of any of Articles H1-H2, further comprising a lighter than air balloon, supporting the airborne device.

H5. The system of any of Articles H1-H4, wherein the airborne device comprises at least two airfoil blades, attached to a hub of a wind rotor, having an axis and capable of rotating around its axis.

H6. The system of any of Articles H1-H5, further comprising:
an airborne electrical generator, driven by the harvested wind energy; and
an electrical cable, connecting the electrical generator to an electrical circuit on the ground.

H7. The system of Article H6, wherein the electrical cable is substantially vertical.

H8. The system of any of Articles H1-H5, further comprising:
an electrical generator on the ground;
a mechanical cable or belt, adapted to transfer energy, harvested by the at least one airfoil blade to the electrical generator.

H9. The system of Article H8, wherein the mechanical cable or belt is substantially vertical.

K1. A method of converting wind power into electrical power,
harvesting the wind power by at least one airfoil blade, coupled to a plurality of tethers;
the plurality of tethers comprising at least three tethers of constant length, attached to the ground at substantial distance between each other; and
employing an electrical generator to convert harvested wind power into electrical power.

K2. The method of Article K1, wherein the substantial distance equals or exceeds half of the altitude of the airborne device.

K3. The method of any of Articles K1-K2, wherein a lighter than air balloon supports the plurality of tethers.

K4. The method of any of Articles K1-K2, wherein a lighter than air balloon supports the airborne blade.

K5. The method of any of Articles K1-K4, wherein at least two airfoil blades are provided, being attached to a hub of a wind rotor, rotating around its axis.

K6. The method of any of Articles K1-K5, further comprising steps of:
making the electrical generator airborne; and
providing an airborne electrical cable, connecting the airborne electrical generator to an electrical circuit on the ground.

K7. The method of Article K6, wherein the electrical cable is placed substantially vertically.

K8. The method of any of Articles K1-K7, wherein the at least one airfoil blade converts wind power only while remaining within a pre-defined cube in the space, the side of the cube smaller than one third of the altitude of the cube's center.

K9. The method of any of Articles K1-K5, further comprising:
placing the electrical generator on the ground;
providing a mechanical cable or belt, transferring the power, harvested by the at least one airfoil blade to the electrical generator on the ground.

K10. The method of Article K9, wherein the mechanical cable or belt is nearly vertical.

Z1. The airborne assembly from any of the Articles above.

Z2. The wind rotor from any of the Articles above.

All referenced patents, patent applications and other publications are incorporated herein by reference, except that in case of any conflicting term definitions or meanings the meaning or the definition of the term from this disclosure applies.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1 shows a perspective view of one embodiment of the invention, comprising a tethered airborne assembly with two wind rotors and a lighter than air balloon.

FIG. 2 shows main forces acting on the airborne assembly in that embodiment.

FIG. 3A shows a view of the airborne assembly with peripheral power take-off and four wind rotors from the tether side in another embodiment t.

FIG. 3B shows a view of the airborne assembly with peripheral power take-off and two rotors from the top in the plane, perpendicular to the tether.

FIG. 4A shown an embodiment with a single wind rotor, a counterweight and buoyant envelope in the rotor center, side view.

FIG. 4B shows the same embodiment, back view.

FIG. 5A shows details of the wheel-rail contact in that embodiment, sectional view tangential to the rail.

FIG. 5B shows the same, view from the side of the envelope.

FIG. 6 shows a perspective view of a “tether tripod” according to another aspect of the invention.

### DETAILED DESCRIPTION OF THE PREFERRED EMBODIMENTS

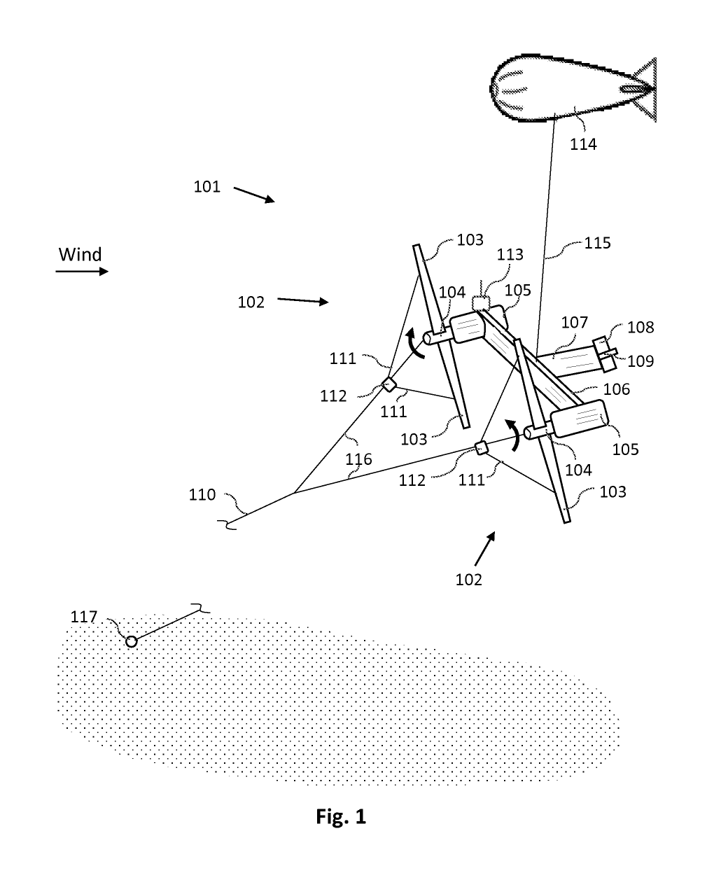

FIG. 1 shows some details of one embodiment of the invention. It comprises an airborne assembly 101 with two counter rotating wind rotors 102. Each wind rotor 102 has two airfoil blades 103, attached to a rotor hub 104. Wind rotor 102 rotates under the power of the wind, harvesting wind energy and transferring it to the rotor of an electrical generator 105. Electrical generator 105 may be of a direct drive type, not requiring a gearbox, or there may be a gearbox between an axle of the wind rotor and the electrical generator. Each electrical generator is placed in a casing, protecting it from weather. The casings are connected by a beam 106. A stabilizer 107 is provided to help assembly 101 to orient itself relative to the wind. Stabilizer 107 can be equipped with a horizontal rudder 108 and vertical rudder (an elevator) 109. Of course, the axes of wind rotors 102 are spaced wider than rotor diameter, so the rotors do not collide. Assembly 101 is tethered to the ground by a tether 110. In FIG. 1, tether 110 is attached to tips of hubs 104 by sub-tethers 116, the hub tips are installed on roller bearings to allow them not to rotate when hubs 104 rotate. Alternatively, tether 110 can be attached to beam 106. In some variations of this embodiment tether 110 is attached to assembly 101 in at least three points, situated not on one line, thus contributing to stabilization of assembly 101. In the described embodiment, an anti-twist device 112 is set on each sub-tether 116. Anti-twist device 112 consists of two rings, an internal one and an external one, freely rotating on the roller bearings relative to each other. The internal ring is fixed around the sub-tether 116. One end of a cable 111 is attached to the external ring of anti-twist device 112, another end is attached to blade 103. Multiple cables 111 can be attached to a single blade, distributed over its length. In operation, cables 111 resist most of aerodynamic forces, acting on blades 103. This allows to make the blades and the whole assembly lighter and less expensive. There is a control system 113, comprising a central processing unit, at least one sensor and at least one actuator to control the system.

Optionally, the assembly may be supported by a lighter than air balloon 114, hanging on a cable 115. If balloon 114 is used, it is preferably designed large enough to raise assembly 101 and tether 110 in the air and to support them when the wind is too weak. All or most of the wind pressure is resisted by the tilt of wind rotors 102, as described below. Tether 110 is attached by an anchor 117 to the ground. If the balloon 114 is used, assembly 101 needs to be brought down only for inspection and maintenance and when the weather is so bad that it threatens existence of the system. If balloon 114 is not used, the whole weight of assembly 101 and tether 110 must be supported by aerodynamic forces, acting on wind rotors 102. Thus, there is a first minimum wind speed, required to launch assembly 101 to the air and raise it to a pre-determined altitude, and a second minimum wind speed, at which assembly 101 should be brought down and raised. The first minimum wind speed is equal or higher than the second minimum wind speed. Also, if balloon 114 is not used, the tilt of wind rotors 102 depends on the wind speed: the angle of the rotor axis to the horizontal plane should generally increase with decrease of the wind speed and decrease with increase in the wind speed. Balloon 114 may be filled with hydrogen, methane, helium or hot air. Hydrogen and methane are the most beneficial options. Balloon 114 may be flexible, rigid or semi-rigid. Optionally, it may be rigidly combined with airborne assembly 101.

The embodiment with sub-tethers 116 and suspension cables 111 is a preferred one. In a more conventional variation, it is possible to connect tether 110 directly to beam 106, and eliminate sub-tethers 116 and cables 111, although this would require stronger blades 303 and other elements of the construction.

In operation, wind causes rotation of wind rotors 102, which harvest some of the wind energy and transfers it to electrical generators 105, which convert it in electrical power. Electrical power is sent to an electrical circuit on the ground through an electrical cable, combined with a tether. The electrical cable can be attached to generators 105 through tips of hubs 104 (FIG. 1) or through wiring in beam 106.

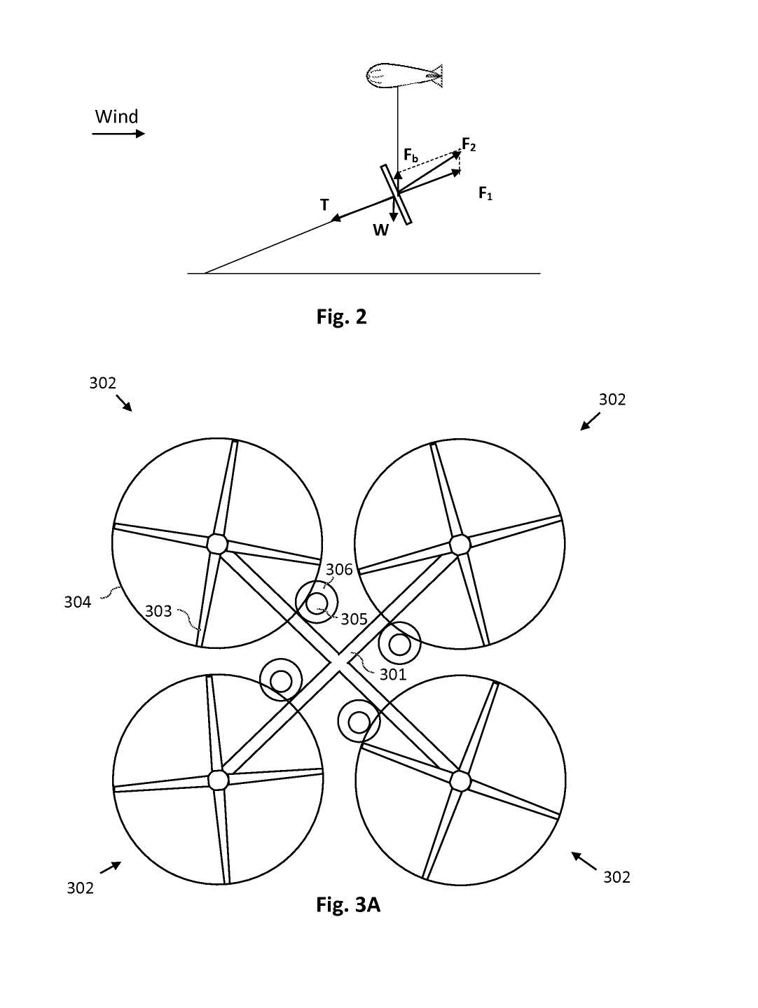

FIG. 2 shows forces, acting on airborne assembly 101: assembly weight W is compensated by the balloon buoyancy F_{b}, tether tension T is compensated by the wind pressure F₁, acting on the assembly perpendicular to the rotor plane. If the balloon is not used, the rotor should be tilted more, so that wind pressure F₂ compensates both tether tension T and weight W.

Preferably, blades 103 can be pitched and are provided with mechanical actuators to pitch them. Blade pitching involves rotating the blades around its long axis. Blade pitching is used for the following purposes:

A. Accommodating various wind speeds. To accommodate higher wind speed, the system decreases blade's angle of attack; to accommodate lower wind speed, the system increases blade's angle of attack. The control system can react to varying load, or it can be provided with a table or formula, defining blade's angle to a pre-defined ‘zero’ position depending on the wind speed and turbulence.

B. Keeping constant angle of attack as the blade moves cyclically in the circle.

C. Position control. The most convenient way of changing the position of the airborne assembly in the space is by changing the pitch of the blades. Easiest it is accomplished on an airborne assembly having at least four wind rotors. To move the assembly in a certain direction, the control system pitches the blades of one or two rotors on the opposite side of the assembly to change the angle of attack in such way as to decrease the lift. Slightly more involved process is required in the case of only two wind rotors. In this case, a cyclic control may be required: each blade of one or both rotors is continuously and cyclically pitched as the blade moves in the circle, achieving higher lift in the direction of the desirable move and lower in the opposite direction.

Another way of changing the position of the airborne assembly in the space is by changing the tilt of the whole assembly (in horizontal and vertical planes, as required).

The airborne assembly may have guarding wires around the rotors to protect the rotor blades from accidental collisions with the cables, tethers and the ground (on launch hand landing). The control system may contain an inertial measurement unit with accelerators, magnetometers, GPS and other sensors to continuously determine the position of the airborne assembly in the space and produce corrective signal. It can further comprise an anemometer, a barometer, tension meters, voltmeters, ampermeters and other sensors for measuring generator output and conditions. It can be equipped with Internet connection to report its state and health and to receive weather forecasts and orders from the operators.

This embodiment is more effective when wind rotor is less than 10 meters in diameter, because the wind rotor maintains significant RPM. For example, for the rotor with diameter 5 meters and tip speed 100 m/s, it makes 380 RPM. As the tips speeds are limited, increase in the diameter will decrease RPM, requiring heavier gearbox or bigger direct drive. Another way to increase produced power is to combine four or more wind rotors into one assembly. The wind rotors can be placed in hexagonal or rectangular mesh pattern in a plane or on a surface of an imaginary sphere.

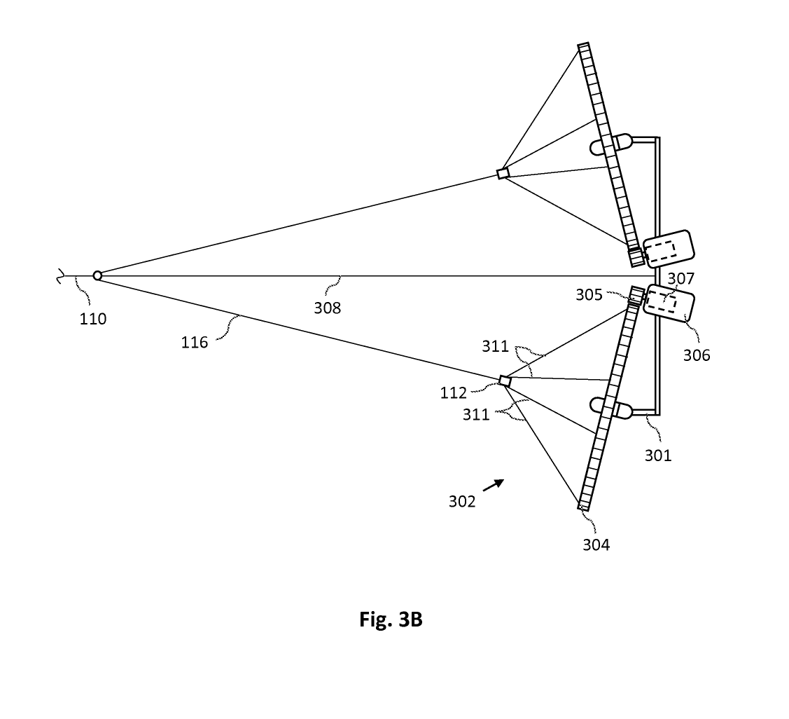

In another embodiment of the invention, harvested wind energy (or power) is removed and converted to electricity not at the wind rotor axis, but on the periphery of the rotor. FIG. 3A shows details of the airborne assembly with four wind rotors in such embodiment, view from the front (i.e., from the tether). The assembly comprises a non-rotating frame 301, to which four wind rotors 302 are attached. Each wind rotor comprises four airfoil blades 303 and a contact ring 304, connected to the tips of these blades. The power is removed by a gear 305, engaging contact ring 304. Gear 305 is on the same axle with an electric rotor 307 of an electrical generator 306 (shown in FIG. 3B), which is attached to frame 301. Contact ring 304 has holes, recesses or teeth engaging teeth of gear 305. In operation, wind causes rotation of wind rotors 302, contact ring 304 transfers the rotation and mechanical power to gear 304, which transfers the mechanical power to electrical generator 306, which converts mechanical power into electrical power. Electrical power is sent to an electrical circuit on the ground through an electrical cable 308, which lays along tether 110 for most of its length. Contact ring 304 can be made of different materials, including steel, aluminum, plastic, fiber reinforced glass or resin etc. Contact ring can be rigid or flexible. A perforated belt or a roller chain can be used in place contact ring 304. In the embodiment, shown in the figures, centrifugal forces increase rigidity of contact ring 304. Friction can be used instead of toothed gearing. In an embodiment with friction, gear 305 is replaced with a wheel (or a tire), and the contact surfaces of this wheel and contact ring 304 are covered with a material or materials, having high friction coefficient (for example, rubber). It should be noted that contact ring 304 can be placed at various angles to the plane of wind rotor rotation (even at zero angle) and at different distances from the axle (not necessarily on the periphery). Also, multiple gears 304 and multiple generators 306 may be used with a single contact ring. Gears 304 are not necessary co-axial with generators 306, and the number of gears does not have to match the number of generators. Also, one generator may work with gears, engaging two contact rings. Any number of blades from two to twenty can be used in the wind rotor.

FIG. 3B is a schematic side view of an airborne assembly with only two wind rotors in this embodiment. It shows how the assembly is connected to tether 110 through sub-tethers 116, anti-twist devices 112 and cables 311, attached to blades 303 and/or contact ring 304. Cables 311 resist all or most wind pressure, allowing to make blades 303 lighter and cheaper.

The embodiment with sub-tethers 116 and suspension cables 311 is a preferred one. Of course, it is possible to connect tether 110 directly to frame 301, and eliminate sub-tethers 116 and cables 311, but this would require stronger blades 303 and stronger frame 301.

Embodiments from FIG. 3A and FIG. 3B have no limits on the diameter of the wind rotors. In most embodiments, the airborne assembly is expected to self-orient and to have a certain reserve of passive stability, with the control system providing active stability and necessary maneuverability.

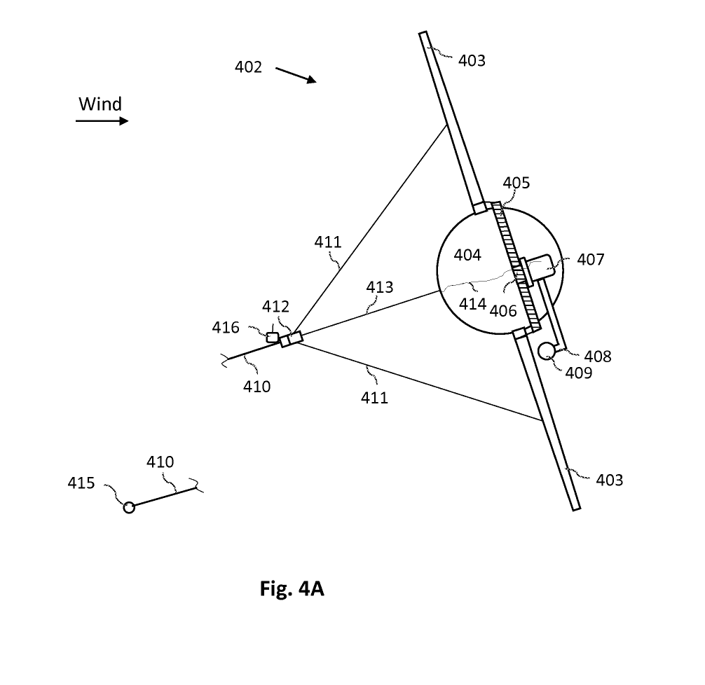

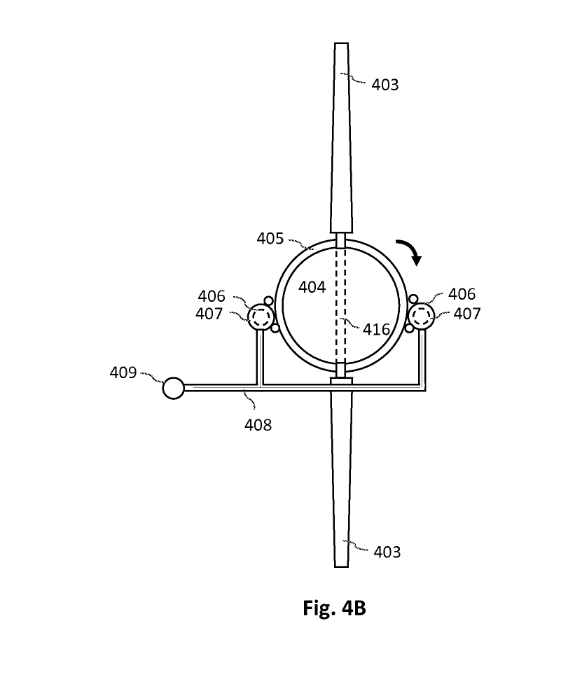

FIG. 4A and FIG. 4B show another example embodiment of the invention (side view and back view, respectively). It comprises an airborne assembly 402, centered on a wind rotor, harvesting wind power. The wind rotor comprises airfoil blades 403, attached to an envelope 404 filled with a lighter than air gas and an annular rail 405 for power takeoff. Airfoil blades 403 are capable of pitching. Envelope 404 can be rigid, semi-rigid or flexible. Spars 416, connecting blades for better rigidity, can pass through envelope 404. Envelope 404 can be spherical. Its volume and buoyancy should be sufficient to keep in the airborne assembly 402 and tether 410, which attaches it to the ground and contains a conducting wire. A wheel 406 is engaged with annular rail 405 by friction or toothed gearing. A rotor of an electrical generator 407 is co-axial or otherwise rotationally coupled to wheel 406. The wheel-generator assembly is not attached to annular rail 405 or envelope 404, but annular rail 405 has profile which prevents the wheel-generator assembly from slipping and falling off it. There are two wheel-generator assemblies. They are attached to an elongated member (a beam, a truss or similar) 408, having on its end a counterweight 409. When the system is in operation, annular rail 405 rotates clockwise (if viewed from the back), the wheel-generator assemblies, rigidly attached to member 408, shift to the point where the moment, created by friction or engagement of annular rail 405 is balanced by the moment of member 408 and counterweight 409. Whole airborne assembly 402 is held in place by tether 410, which is attached to one end of an anti-twist device 412. To another end of device 412 attached are a cable 413 and cables 411. Cables 411 support blades 403 against aerodynamic forces. Cables 411 are pre-stressed to counteract back flap motion of blades 403. Blades 403 can be connected to annular rail 405 by additional cables, reinforcing them in the plane of rotation. Nevertheless, the aerodynamic forces acting perpendicular to the plane of rotation are typically around ten times stronger than forces in the plane of rotation. Cable 413 is attached to envelope 404. Further, there is a wire 414, passing along cable 413, connecting generator 407 to the wire in the tether, which is connected to a grid through ground connection 415. There is an electronic control system 416 with both airborne and ground based elements. In addition to providing lift, envelope 404 may accelerate air flow in the internal part of the rotor. The number of blades can be anywhere from one to twelve, although two to four are preferable. The number of generators 407 can be from one to twenty, although two to eight is preferred. Cables 411 may have a streamlined profile. Elements of this embodiment may be similar to analogous elements from the embodiments described above.

When the system operates, the wind brings into rotational motion blades 403, which harvest the wind power and bring into motion annular rail 405. Annular rail 405 engages wheels 406, which rotate the rotors of generators 407, which convert the harvested mechanical power into electricity, which is transferred through wires 414, tether 410 and ground connection 415 to the users. Envelope 404 rotates together with annular rail 405. When the system does not operate because the wind is too slow, it is maintained in the air by the buoyancy of envelope 404. The airborne assembly can be launched by simply letting tether 410 to unreel, and can be landed by reeling tether 410 in. The altitude can be controlled by cyclically pitching blades 403, among other methods. Further, control system 416 should use active cyclical pitch control to stabilize airborne assembly 402 in the horizontal and vertical planes, and especially to eliminate horizontal torque, caused by the vertical tilt of the rotor plane.

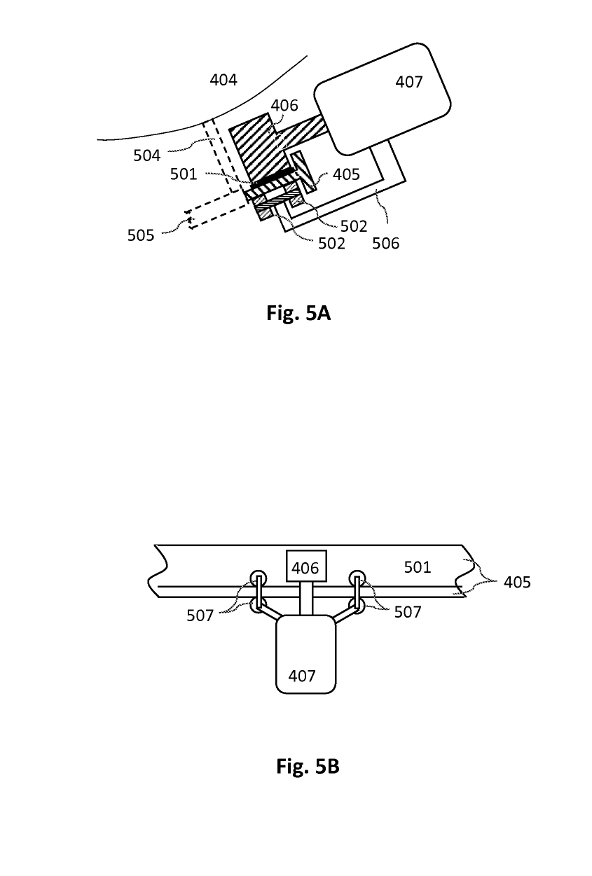

FIG. 5A and FIG. 5B (the sectional view tangential to the rail and the view from the envelope 404, respectively) show details of the mechanism, with which the wheel-generator assembly holds to rail 405. Rail 405 has T-shaped section. Its side, facing envelope 404, has surface 501, engaging wheel 406. It can engage it by friction (when both surface 501 and wheel 406 are covered by rubber or other high friction material) or by linkage (when wheel 406 is a gear and surface 501 has teeth or perforation). Rollers 502 snuggle the opposite side of rail 405. Rollers 502 are attached to an arm 506, which is attached to the housing of generator 407. Members that attach rail to envelope 404 and the blades are shown in dashed lines and numbered 504 and 505, respectively. In order to prevent wobbling of the wheel-generator assembly in the plane of rail 405, eight rollers, attached to the housing of generator 407, are used. Four of them are shown in FIG. 5B. Rail 405 can be made of steel, aluminum, fiberglass, carbon fiber and other sufficiently strong material.

Example system parameters: altitude −200 m; rotor diameter −50 m; rail diameter −20 m; rotor tilt angle −30°; tether angle to the horizon −30°; nominal wind speed −15 m/s; nominal blades tip speed −100 m/s; rail speed −40 m/s; diameter of wheel 406-0.45 m; length of member 408-80 m; nominal power −2 MW.

The embodiments, described above, allow to make airborne wind energy systems lighter, cheaper, safer and more powerful than based on designs, known in the art. Combination of buoyant lift of lighter than air balloon and aerodynamic lift of the rotating on the wind rotor, tilted as described, allows to raise and keep the wind rotors in the air without wind—unlike designs, using only aerodynamic lift. In the same time, the balloon remains small and inexpensive, because the strong wind pressure is resisted by the aerodynamic forces that become stronger with strengthening wind. This is in contrast with the very large balloons required by the prior art systems that use only buoyancy, which is supposed to compensate large downward force, which is the sum of the horizontal wind pressure on the wind rotor and tension of the tether. The combination of buoyancy and dynamic lift also increase safety of the system—when one of them fails, another one can take over and keep the assembly in the air and/or to ensure smooth landing.

Further, supporting rotor blades along their length by external cables, preferably attached to the tether, allows to significantly decrease the blades' weight compared with the existing designs, where the aerodynamic forces, acting on the blade, are resisted by bending at blade's root. This allows to make the rotor radically lighter.

Further, power take-off from a contact ring or rail, which can move with a speed of 15-120 m/s, allows to achieve high RPM of the electric rotor without use of a gearbox or a direct drive generator. This additionally saves weight, increases reliability and decreases the cost of the system.

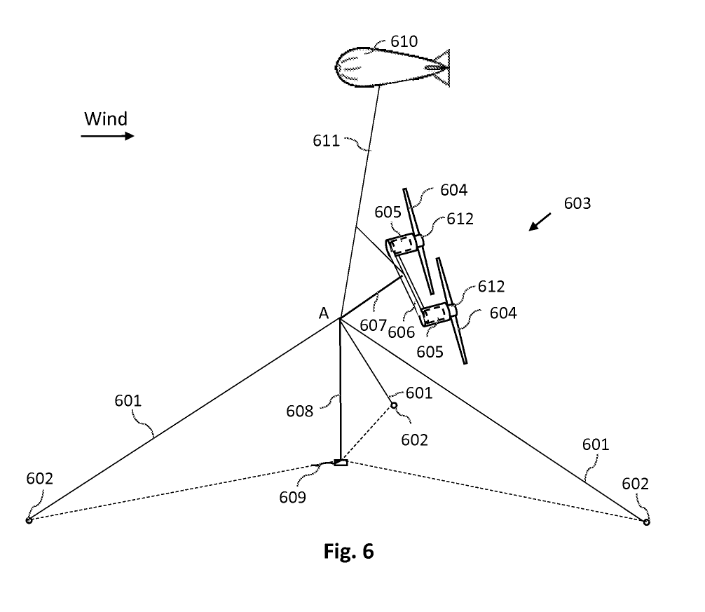

FIG. 6 shows some details of another embodiment of the invention. It comprises an airborne wind energy conversion device 603, attached to the ground by three tethers 601 as follows. Tethers 601 connect to each other in a single point A in the air, and are anchored in the ground in vertices of an equilateral triangle by anchors 602. Device 603 comprises two wind rotors 612, each with two or more blades 604, the wind rotors are coupled to airborne electrical generators 605, attached to a common frame 606. Wind rotors 612 are counter rotating. Common frame 606 may be attached to point A by a short tether 607, containing an electrical cable. Alternatively, tethers 601 can be attached directly to common frame 606, in which case point A is on common frame 606. In operation, the wind rotates wind rotors 612, which harvest wind power and convert it into mechanical power of the electric rotor of electrical generators 605. Electrical generators 605 convert the mechanical power into electric power. An electrical cable 608, connected to generators 605, hangs from point A vertically down. On the ground, it is connected to the grid or another electrical circuit 609, possibly through a transformer. These cables transmit electric power, generated by generators 605, to the electricity consumers on the ground. Device 603 can freely rotate around point A in the horizontal plane, so it is oriented (actively or passively) downwind from point A. Further, the plane of rotation of wind rotors 612 is tilted in the vertical plane, so that the wind pressure on wind rotors 612 has a significant vertical component upward. This component compensates the weight of device 603, tethers 601 and cable 608, allowing them to say in the air when there is sufficiently strong wind. Optionally, there is a lighter than air balloon 610, supporting the system in the air on a mechanical cable 611, when there is no wind. If balloon 610 is not used, the system must be landed each time when the wind speed drops below a pre-defined value, and raised again when the wind speed exceeds another pre-defined value.

Tethers 601 have constant length (not necessarily the same). It is easy to see that in this embodiment point A and device 603 are always in substantially the same place in the 3D space. This position does not change with the changes the wind speed or direction. This feature remediates one of the most serious shortcomings of airborne wind energy systems—that they can move all over the place, anywhere within a hemisphere with the center in the tether attachment point and the radius equal to the length of the tether. The occupied or impacted area is diminished. The proposed embodiment eliminates danger to aircraft, flying above the altitude of balloon 610, and to humans, animals and objects on the ground, except for the area directly below point A. Further, this embodiment allows to decrease the length of the electrical cable, which goes directly from device 603 down to the ground, compared with the electrical cable, used in the existing or proposed AWES with flying generator, where it has to go along a tether. Thus, both the weight and the electrical resistance of the cable proportionally decrease.

Device 603 may be attached to the ground by more than three tethers. The placement of anchors 602 should be selected depending on the features of the terrain and the wind rose (vertices of an equilateral triangle are brought by way of example.) While most benefits are achieved when the multi-tether system is used for attaching a rotary wing energy conversion device with a flying generator, it can be used with other types of airborne wind energy systems. In more embodiments, harvested energy can be transferred from the airborne wind energy harvesting device to the ground using a mechanical cable or belt, extended down from point A.

Thus, an airborne wind energy system and method with rotary wing and flying generator is described in conjunction with one or more specific embodiments. While above description contains many specificities, these should not be construed as limitations on the scope, but rather as exemplification of several embodiments thereof. Many other variations are possible and contemplated.

What is claimed is:

1. An airborne wind energy conversion system, comprising:
an airborne wind rotor, having a plurality of airfoil rotor blades;
the rotor is adapted to rotate around its axis under the power of wind;
at least one external cable, attached to each rotor blade in such a way that is capable of supporting the blade against aerodynamic force;
a tether, coupled to the external cables, the tether being attached to the ground;
an airborne electrical generator, having an electric rotor rotationally coupled to the wind rotor; and
a lighter than air member, supporting the wind rotor.

2. The system of any of claim 1, wherein the external cables are directly connected to the tether.

3. The system of any of claim 1, comprising an even number of airborne wind rotors.

4. The system of any of claim 1, wherein the electrical generator is of direct drive type.

5. The system of any of claim 1, further comprising an electrical cable, connecting the electrical generator to an electrical circuit on the ground.

6. The system of any of claim 1, wherein the blades can pitch.

7. A method of converting wind power into electrical power using an airborne wind energy conversion system with a tether and a wind rotor with a plurality of airfoil blades, the method comprising:
supporting each rotor blade against aerodynamic lift with at least one external cable, the cable being attached by one end to the blade and by another end to the tether or an extension of the tether;
providing an airborne electrical generator, having an electric rotor rotationally coupled to the wind rotor;
supporting the airborne electrical generator by a lighter than air member;
and using an electronic control system to control at least the wind rotor.

7. The method of any of claim 6, wherein the external cables are directly connected to the tether.

8. The method of any of claim 6, wherein there is an equal number of the wind rotors rotating clockwise and rotating counter-clockwise.

9. The method of any of claim 6, wherein the electrical generator is connected to an electrical circuit on the ground by an electrical cable, combined with the tether.

10. The method of any of claim 6, wherein the blades can pitch.

11. An airborne wind energy conversion system, comprising:
an airborne wind rotor, having a plurality of airfoil rotor blades, the rotor is adapted to rotate around its axis under the power of wind;
at least one airborne drivetrain, comprising an electrical generator, the drivetrain being adapted for power take off from the middle part or periphery of the wind rotor;
a tether, attaching the wind energy system to the ground;
the drivetrain being adapted for power take off from the middle part of the wind rotor.
